(19) United States
(12) Patent Application Publication
(10) Pub. No.: US 2008/0041298 A1
(43) Pub. Date: Feb. 21, 2008

(54) Substrate with protected temperature sensing coating layer

(76) Inventor: Ping-kun Lin, Changhua County (TW)

Correspondence Address: PING-KUN LIN, 235 Chung-Ho, Box 8-24, Taipei, omitted

(21) Appl. No.: 11/505,191

(22) Filed: Aug. 17, 2006

(51) Int. Cl. G01K 1/02

(52) U.S. Cl. 116/216

(57) ABSTRACT

A substrate with protected temperature sensing coating layer comprises a substrate; a temperature sensing coating layer having at least one color and being formed with patterns; and a plastic protection layer upon the temperature sensing coating layer. The plastic protection layer is applied to the temperature sensing coating layer by coating at liquid form, or pouring or molding. Material of plastic protection layer is selected from one of PU (polyurethane), POLY, silicon and TPU. The temperature sensing coating layer is printed upon the substrate.

### FIELD OF THE INVENTION

The present invention relates to a substrate with protected temperature sensing coating layer, wherein the plastic protection layer is applied to the temperature sensing coating layer by coating with the protecting material being at liquid form, or by pouring or molding.

### BACKGROUND OF THE INVENTION

In Taiwan Patent No. 93209422, “a TPU leather product with light effect”, a temperature sensing light affect layer is formed on the surface of a TPU layer (structure). Colors of the temperature sensing light affect layer are changed with the variation of temperature so as to provide an interest affect to users. Furthermore, a plastic protection layer is adhered upon the temperature sensing light affect layer.

However above mentioned prior art has the following disadvantages.

Firstly, as the TPU material is combined with shoes or pockets, high frequency technology is used for providing high adhesion. However the prior art layer only flatly adhered upon the substrate, while for non-flat structure or only one character is used, this prior art way is not suitable.

Secondly, the TPU leather object with light affect is combined with a product by high frequency technology. The combination will damage the structure so that the appearance of the substrate is not flat and not uniform.

Thirdly, to improve above first and second defects, the temperature sensing material is mixed with plastic material. Then the mixture is injected upon a 3 dimensional structure. However the temperature sensing coating layer is not heat tolerant to temperatures over 180° C. Thus the chemical property of the material will be destroyed so as to lose the activity and tolerance of the material. As a whole, the prior art way for combining the temperature sensing material and plastic protection layer is not ideal.

### SUMMARY OF THE INVENTION

Accordingly, the primary object of the present invention is to provide a substrate with protected temperature sensing coating layer, wherein the plastic protection layer is applied to the temperature sensing coating layer by coating at liquid form, or pouring or molding.

To achieve object, the present invention provides a substrate with protected temperature sensing coating layer which comprises a substrate; a temperature sensing coating layer having at least one color and being formed with patterns; and a plastic protection layer upon the temperature sensing coating layer. The plastic protection layer is applied to the temperature sensing coating layer by coating at liquid form, or pouring or molding. Material of plastic protection layer is selected from one of PU (polyurethane), POLY, silicon and TPU. The temperature sensing coating layer is printed upon the substrate.

The various objects and advantages of the present invention will be more readily understood from the following detailed description when read in conjunction with the appended drawing.

### BRIEF DESCRIPTION OF THE DRAWINGS

FIG. 1 shows the manufacturing process of the temperature sensing coating layer of the present invention.

FIG. 2 shows another embodiment of the present invention, wherein the substrate has a heart like shape.

FIG. 3 is a partial schematic view of the temperature sensing coating layer of the present invention.

FIG. 4 is a perspective view showing another embodiment of the present invention, where the structure is a non-flat structure.

FIG. 5 is a partial schematic view of FIG. 4.

FIG. 6 shows a further embodiment of the present invention, where the temperature sensing coating layer is formed as small characters.

FIG. 7 shows a still embodiment of the present invention, where the plastic protection layer is only partially applied to the temperature sensing coating layer.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

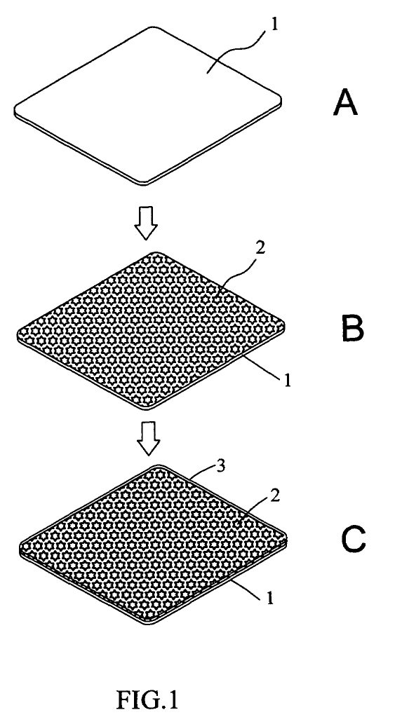

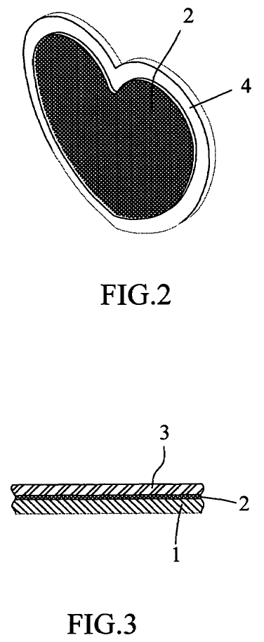

Referring to FIGS. 1 and 2, the structure of the present invention is illustrated. The present invention has the following elements.

A substrate 1 is selected from one of plastic, leather, cloth, ropes, etc. A surface of the substrate 1 is formed with a temperature sensing coating layer 2 which is formed by temperature sensing material. The temperature sensing coating layer 2 may be formed as characters, textures, and patterns of single or multiple colors. Besides, the colors of the temperature sensing coating layer 2 are varied with temperature variation. To protect the temperature sensing coating layer 2 from cracking or scraping, a plastic protection layer 3 is printed upon the temperature sensing coating layer 2.

The process for manufacturing the present invention will be described herein with reference to FIG. 1. The present invention includes the steps of (A) preparing a layer of substrate 1 which is selected from one of plastic, leather, cloth, ropes, etc.; (B) form a temperature sensing coating layer 2 upon the substrate 1; and (C) coating a plastic protection layer 3 upon the temperature sensing coating layer 2 so as to have a structure with the protection layer and temperature sensing coating layer.

To match the coating technology, PU (polyurethane), POLY, silicon, etc., which has liquid form in normal temperature are used as the plastic protection layer 3 so that the plastic protection layer 3 can be coated upon the temperature sensing coating layer 2 quickly. Then the structure can be dried by normal wind or heating so that the plastic protection layer 3 can be combined with the temperature sensing coating layer 2 firmly.

In the present invention, that the plastic protection layer 3 coats upon the substrate 1 with a liquid form can induce the advantage of providing a smooth and warm feeling to users as illustrated in FIG. 2 in that, a substrate 1 with a heart shape is illustrated.

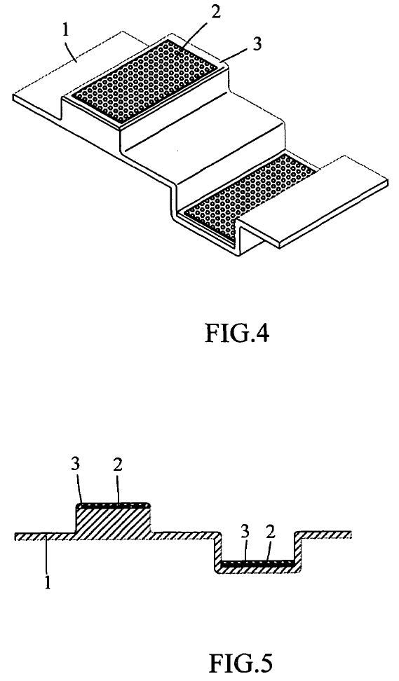

Referring to FIGS. 4 and 5, the substrate 1 is bended with multiple folds. In this structure, the temperature sensing coating layer 2 is coated upon the substrate 1 and then a plastic protection layer 3 is poured upon the temperature sensing coating layer 2 so as to fill the gaps upon the temperature sensing coating layer 2 and the substrate 1. This can be performed easily. However the prior art way is slow and difficult and may destroy the appearance. In the prior art, the temperature sensing coating material is mixed with plastic particles and then the mixture is injected out in high temperature. This prior art way can generate a three dimensional structure, but the high temperature will short the lifetime of the structure and the effect is bad.

In the present invention, the plastic protection layer 3 is poured upon the non-flat temperature sensing coating layer 2. The plastic protection layer 3 will not be too thick to destroy the temperature sensing coating layer 2. Moreover the temperature sensing speed of the temperature sensing coating layer 2 will not affected.

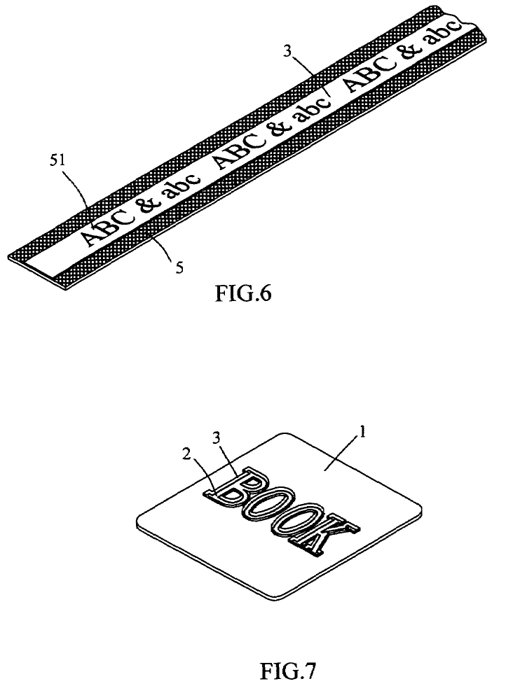

Referring to FIG. 6, a long substrate 5 is illustrated. A temperature sensing coating layer 2 is formed as a series of small characters 5. The plastic protection layer 3 is combined with the surface of the temperature sensing coating layer 2. As shown in FIG. 6, the plastic protection layer 3 can be coated upon the long substrate 1 or coated with a form a specific shape.

Referring to FIG. 7, the temperature sensing coating layer 2 is formed as a specific shape or character and the plastic protection layer 3 is only coated upon the shape or character. Thus, the defect in the prior art can be avoided. In the present invention, the micro residue glue on some minor portions due to the high frequency work on the characters is difficult to be removed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A substrate with protected temperature sensing coating layer comprising:
a substrate;
a temperature sensing coating layer having at least one color and being formed with patterns; and
a plastic protection layer upon the temperature sensing coating layer.

2. The substrate with protected temperature sensing coating layer as claimed in claim 1, wherein the plastic protection layer is applied to the temperature sensing coating layer by coating at liquid form, or pouring or molding.

3. The substrate with protected temperature sensing coating layer as claimed in claim 1, wherein material of plastic protection layer is selected from one of PU (polyurethane), POLY, silicon and TPU.

4. The substrate with protected temperature sensing coating layer as claimed in claim 1, wherein the temperature sensing coating layer is printed upon the substrate.
